(19) United States
(12) Patent Application Publication
(10) Pub. No.: US 2015/0165596 A1
(43) Pub. Date: Jun. 18, 2015

(54) Strap and Tensioning Mechanism for Attaching Flotation Modules to Marine Structures, namely Port Security Barriers (PSBs)

(71) Applicant: Truston Technologies, Inc., Broussard, LA (US)

(72) Inventor: Jim Andersen, Oxnard, CA (US)

(21) Appl. No.: 14/516,080

(22) Filed: Oct. 16, 2014

Related U.S. Application Data
(60) Provisional application No. 61/891,457, filed on Oct. 16, 2013.

(51) Int. Cl. B25B 5/14; B25B 5/16

(52) U.S. Cl. CPC B25B 5/147; B25B 5/16

(57) ABSTRACT

A strap and tensioning mechanism for attaching flotation modules to sections of Port Security Barriers (PSBs) is disclosed. Preferably, the strap is made from non-metallic fibers, preferably in an axially aligned or linear configuration, to form the strap, the fibers preferably being made of Aramid. Other strong synthetic fibers exhibiting desired thermal and other properties are suitable, as well.

### CROSS REFERENCE TO RELATED APPLICATIONS

This regular United States patent application claims priority to U.S. provisional patent application Ser. No. 61/891,457, filed Oct. 16, 2013, for all purposes. The disclosure of that provisional patent application is incorporated herein by reference, to the extent that it is not inconsistent with any portion of this regular patent application.

### BACKGROUND

Land based assets adjacent to waterbodies, such as dock facilities, harbor facilities, ports, etc., referred to generally as “ports” herein, require protection from water-conveyed threats. In response, a number of types of Port Security Barriers (“PSBs”) have been developed. While designs vary, many PSBs comprise metal and/or composite structures which float offshore of the port facilities, by virtue of flotation modules fixed to the PSB structures.

Traditionally, galvanized mild steel strap has been used to attach the flotation modules to the PSB structures. In a marine environment, particularly a saltwater environment, any steel component presents potential issues related to corrosion. As can be readily understood, severe corrosion will compromise the strength of the steel strap, in turn creating the risk of detachment of the flotation module, sinking of the PSB and exposure of the port facility to water-conveyed risks.

In addition to corrosion, steel possesses a relatively high coefficient of thermal expansion, resulting in a relatively high degree of expansion/contraction with temperature swings. Such repetitive lengthening/shortening of the strap can loosen connections and also result in loss of flotation modules.

There is accordingly a need for improved means of attaching flotation modules to PSBs.

### SUMMARY OF THE INVENTION

The present invention comprises a non-metallic strap assembly which surrounds the flotation module and attaches it securely to the PSB. Various high strength fibers, for example fibers generally in the Aramid family, are preferably used (in an axially aligned/linear configuration, although it is possible that a woven configuration could be used) to fabricate the strap. Non-corrosive (e.g. stainless steel) or protected (e.g. galvanized or other plating on steel) fittings and hardware (or possibly high strength non-metals) connect the strap to the cradle of the PSB structure. The lightweight, non-corrosive fiber strap has a 30+ year seawater life, with high strength, low elongation and low creep. In addition, the fiber strap is flexible and easily accommodates different sizes/shapes of flotation modules with a lower coefficient of thermal expansion than steel. The strap assembly is easy to retrofit on existing structures.

### BRIEF DESCRIPTION OF THE DRAWINGS

FIGS. 1 and 2 are side and perspective views of an embodiment of the fiber strap of the present invention.

FIG. 3 is a perspective view of an embodiment of the fiber strap and related fastening hardware, holding a flotation module to a PSB.

FIG. 4 is a top view of the application of FIG. 3, showing one end of the fiber strap and related fastening hardware.

FIG. 5 is a is a cross-section view of the application of FIG. 4, along Section A-A.

FIG. 6 is a view of the other end of the fiber strap and related hardware.

FIG. 7 is a perspective view of another embodiment of the fiber strap and related fastening hardware, holding a flotation module to a PSB.

FIG. 8 is a top view of the application of FIG. 7, showing one end of the fiber strap and related fastening hardware.

FIG. 9 is a is a cross-section view of the application of FIG. 8, along Section A-A.

FIG. 10 is a view of the other end of the fiber strap and related hardware.

FIG. 11 is a perspective view of another embodiment of the fiber strap and related fastening hardware, holding a flotation module to a PSB.

FIG. 12 is a top view of the application of FIG. 11, showing one end of the fiber strap and related fastening hardware.

FIG. 13 is a is a cross-section view of the application of FIG. 12, along Section A-A.

### DESCRIPTION OF THE INVENTION

While various changes may be made to form different embodiment of the present invention, by way of illustration and not limitation some of the presently preferred embodiments can be described in connection with the drawings. It is to be noted that any dimensions, materials, tolerances, etc. noted on the drawings are by way of illustration only, and do not constitute any limitation on the scope of the invention.

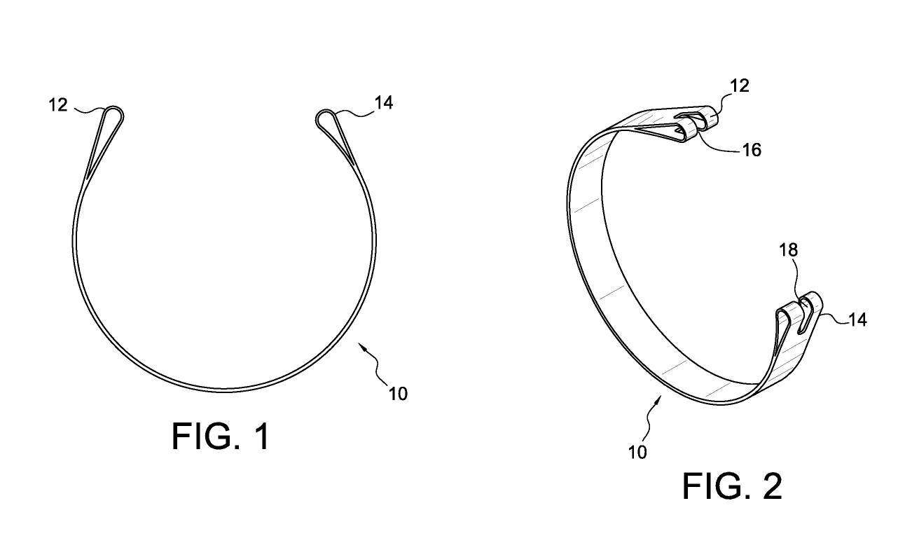

The present invention comprises a fiber strap, with related mounting hardware, for fixing flotation modules to PSBs. FIGS. 1 and 2 are side and perspective views, respectively, of the strap portion of the invention. Strap 10 has dimensions (width, length, thickness, number of layers, etc.) suitable to partially encircle a flotation module so as to hold it to a PSB. Strap 10 is preferably made from a high strength fiber material. While a number of materials might be suitable, as discussed further below, a presently preferred embodiment comprises fibers in the Aramid family, preferably in an axially aligned or linear configuration (although it is possible that a woven configuration could be used), to construct the strap. Strap 10 may be formed from an endless loop of material, thereby making a two layer strap with doubled over ends 12 and 14, as can be seen. Cutouts 16 and 18 enable mounting hardware to be attached to the doubled over ends, to in turn allow mounting to the PSB.

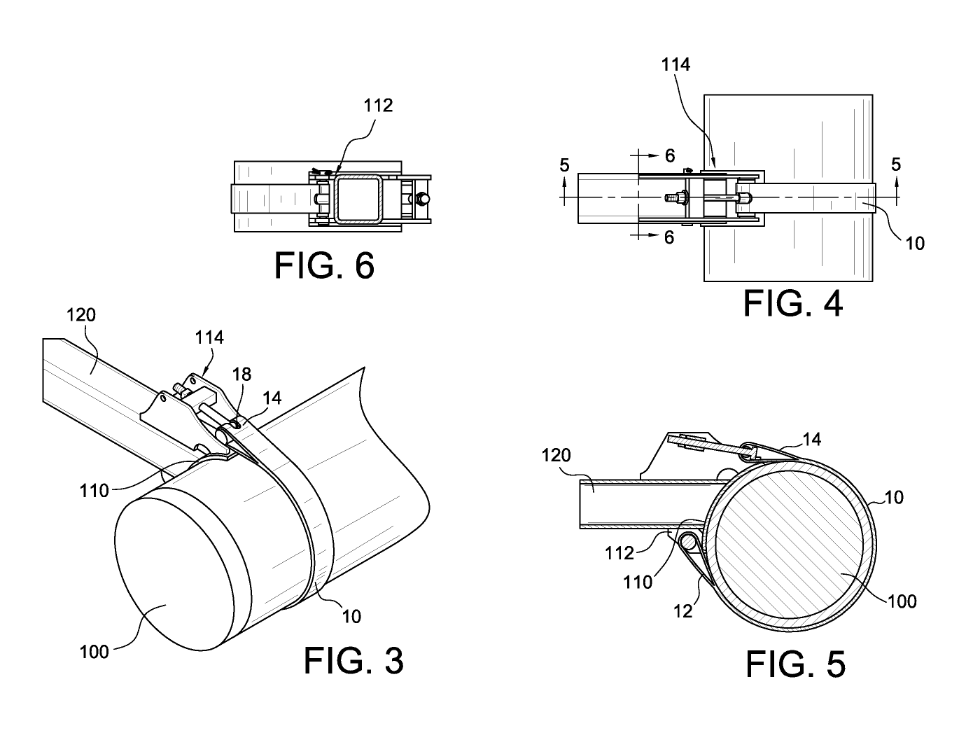

FIGS. 3-6 illustrate one embodiment of the strap assembly in use. FIG. 3 is a perspective view, showing strap 10 partially encircling flotation module 100. Flotation module 100 is held against a saddle 110, in turn connected to the PSB by appropriate structural member 120.

FIG. 4 is a top view of the installation of FIG. 3, while FIG. 5 is a section view along A-A in FIG. 3. Typically, one end of strap 10 is fixed to saddle 110 by a bolt inserted through one end, for example end 12, the bolt being held within a bracket assembly 112, as can be seen in FIG. 6. The other end of strap 10 is connected to a tensioning mechanism 114, mounted in bracket assembly 116, comprising an “all thread” rod, nut, and cross bolt, all as is well known in the relevant art field and shown in the figures. The tensioning mechanism permits tightening of strap 10 so as to hold it securely against saddle 110, and permits relaxing strap 10 in the event that adjustment, replacement of the flotation modules, etc. is needed. Flotation module 100 is held against a saddle 110, in turn connected to the PSB by appropriate structural member 120.

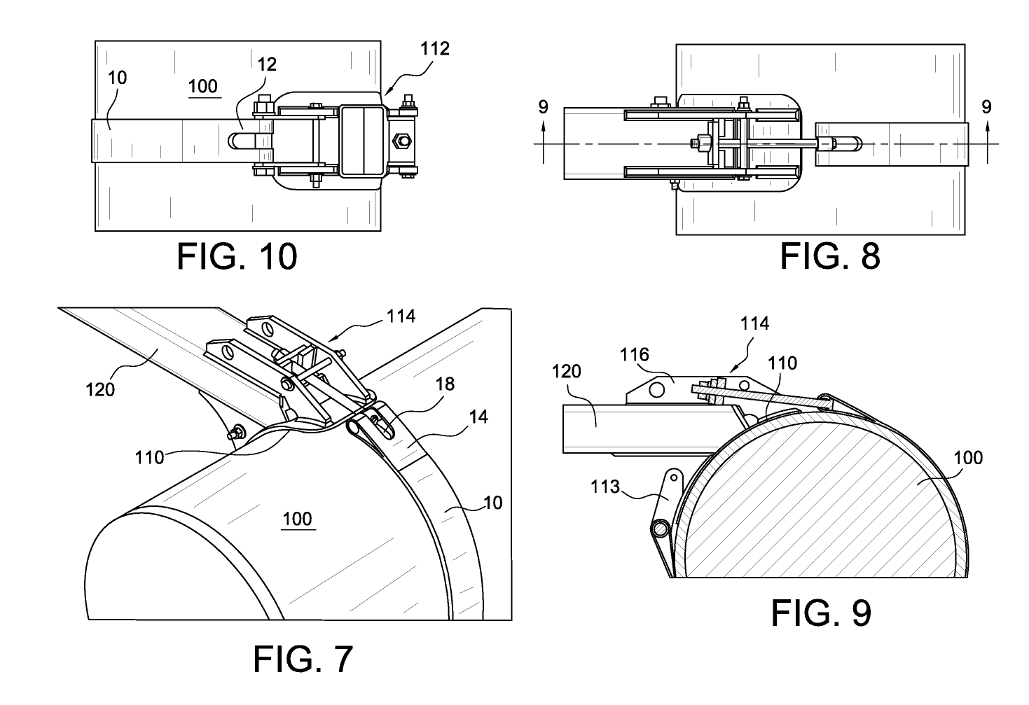

FIGS. 7-10 illustrate another embodiment of the strap assembly in use. FIG. 7 is a perspective view, showing strap 10 partially encircling flotation module 100. FIG. 8 is a top view of the installation of FIG. 7, while FIG. 9 is a section view along A-A in FIG. 8. Typically, one end of strap 10 is fixed to saddle 110 by a bolt inserted through one end, for example end 12, the bolt being held within a bracket assembly 112, as can be seen in FIG. 10. This embodiment additionally shows link plates 113, which are intermediate members between the bracket and the end of the strap. As can be seen in FIG. 8, and as in the previous embodiment, the other end of strap 10 is connected to a tensioning mechanism 114, mounted in bracket assembly 116, comprising an “all thread” rod, nut, and cross bolt, all as is well known in the relevant art field and shown in the figures. The tensioning mechanism permits tightening of strap 10 so as to hold it securely against saddle 110, and permits relaxing strap 10 in the event that adjustment, replacement of the flotation modules, etc. is needed.

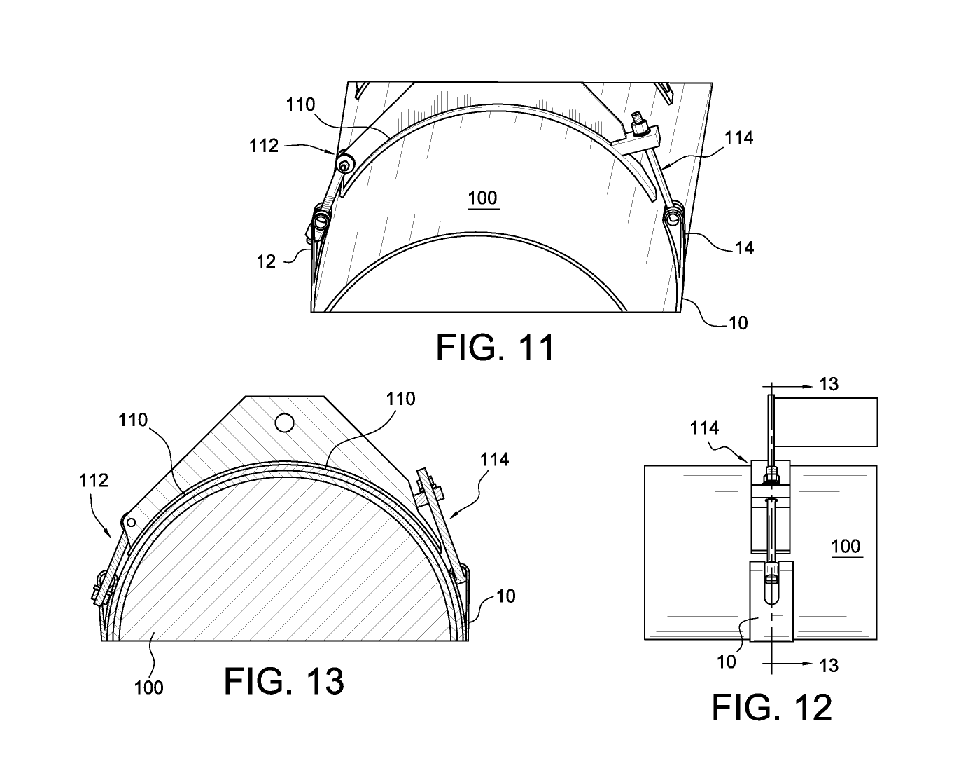

FIGS. 11-13 show yet another embodiment of the strap assembly. This embodiment utilizes somewhat modified fixed end and adjustable end, but shares a number of attributes with the previous two embodiments.

### Suitable Materials for the Strap

As noted above, the retaining strap embodying the principles of the present invention comprises non-metallic, and non-corrosive, yet strong and flexible, material. While a number of materials may be suitable, Aramid is presently seen as one of the preferred embodiments. Broadly, the strap is formed from jacketed fibers, preferably in an axially aligned or linear configuration. Suitable straps provide breaking strengths from 5.5 kips to 22.5 kips, with widths from 2.5 in to 3.5 in respectively.

As known in the relevant art, Aramid fiber is a fiber formed from an “aromatic polyamide”. Aramid fibers are fibers in which the chain molecules are highly oriented along the fiber axis, thereby permitting the strength of the chemical bond to be exploited. Aramids share a high degree of orientation with other fibers such as ultra high molecular weight polyethylene.

More generally, fibers that satisfy the requirements of the intended application, that may be suitable under certain conditions and that therefore fall within the scope of the present invention, comprise fibers which exhibit:
a good resistance to abrasion;
a good resistance to organic solvents;
that are nonconductive;
that exhibit no no melting point, with thermal degradation starting only at high temperatures, for example 500° C.;
exhibit low flammability.

Other suitable fibers may include those sometimes referred to as “para-aramids,” such as Kevlar® and Twaron, which provide high strength-to-weight properties; a high Young's modulus; high tenacity; low creep; and generally low elongation at break (˜3.5%). Still other suitable fibers may include those fibers commonly known as “meta-aramids,” of which Nomex® is an example. Still other suitable fibers, and fabrics made therefrom, may include such materials as Innegra®, Spectra®, Vectran®, and nylon. These fibers may be jacketed, encased or coated in polyurethane, polyuria, or other thermoplastic elastomeric (TPE) materials.

It is desirable, with any of the above mentioned materials, to select fibers and straps fabricated therefrom, to achieve desired specific tensile strengths, along with thermal properties, that are reasonably closely aligned with the thermal properties of the flotation modules (buoyant members) which are being secured to the PSB, or to saddles or other structure of the PSB. This is much more readily done with the strap of the present invention, as compared to prior art metal straps or bands, which have a considerably different thermal properties than the (generally) non-metallic flotation modules. These different properties of the prior art bands could give rise to expansion/contraction issues, etc.

### The Mounting Hardware

It is to be understood that the mounting hardware (namely, the members connecting to the ends of strap 10, and ultimately connecting it to the PSB) may take a variety of forms and be of a variety of materials. Currently preferred embodiments use non-corrosive steel, such as stainless steel; or protected steel, such as galvanized or otherwise plated steel. It is to be understood that some of all of the elements of the connecting hardware might be made of high-strength non-metals, such as high strength composites, etc.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof. For example, various materials can be used for the fiber of the strap, including Aramid-family fibers and other high strength, low elongation and low creep materials which do not degrade in marine environments; dimensions of the strap and related parts can be altered to suit particular applications; etc.

Therefore, the scope of the invention is to be determined not by the illustrative examples set forth above, but by the appended claims and their legal equivalents.

We claim:

1. An apparatus for attaching a flotation module to a port security barrier (PSB), comprising:
a non-metallic strap encircling said flotation module;
a tensioning mechanism attached to said PSB, with said strap engaged with and tensioned by said tensioning mechanism;
whereby said flotation module is firmly engaged with said PSB and maintains said PSB at a desired position with respect to the surface of a waterbody.

2. The apparatus of claim 1, wherein said non-metallic strap is formed from Aramid fibers.

3. The apparatus of claim 1, wherein said non-metallic strap is formed from a para-Aramid fiber.

4. The apparatus of claim 1, wherein said non-metallic strap is formed from ultra high molecular weight polyethylene.

5. The apparatus of claim 1, wherein said non-metallic strap is formed from elastomeric polyurethane.

6. The apparatus of claim 5, wherein said elastomeric polyurethane comprises fibers embedded therein.

7. The apparatus of claim 1, wherein said strap is selected to yield thermal characteristics consistent with thermal characteristics of said flotation module.

8. The apparatus of claim 1, wherein said tensioning mechanism comprises a threaded rod, a nut, and a cross bolt attaching said strap to said tensioning mechanism.
